(19) United States
(12) Patent Application Publication
(10) Pub. No.: US 2012/0279801 A1
(43) Pub. Date: Nov. 8, 2012

(54) APPARATUS AND METHOD FOR PROVIDING CLIMB ASSISTANCE

(76) Inventors: Jonathan Watson, Edinburgh (GB); James Godsell, Dunfermline (GB); Jesper Frederiksen, Bathgate (GB); Oliver Bassi, Edinburgh (GB); Alastair Kilgour, Newtongrange (GB)

(21) Appl. No.: 13/321,020

(22) PCT Filed: May 18, 2010
(86) PCT No.: PCT/GB2010/050814

§ 371 Date: Jun. 28, 2012

(30) Foreign Application Priority Data
May 19, 2009 (GB) 0908587.9

(51) Int. Cl. A63B 69/00; B66D 1/48

(52) U.S. Cl. 182/19

(57) ABSTRACT

The present invention relates to an apparatus for providing ascent assistance comprising: a motive force generator; a motive force applicator operably linked to the motive force generator, and, in use of the apparatus, an object to which the motive force applicator applies a motive force, and a control mechanism comprising a load sensing means and a haulage force application means; said control mechanism being formed and arranged so as to control the motive force generator in a first, calibration, in which it detects a load applied to motive force applicator by the object and said haulage force is determined as a percentage of the applied load; the control mechanism being operable to switch the operation of the motive force generator into a second, assisted ascent mode. The invention further relates to a method for assisting a user in an ascent when working at height.

The present invention relates to an apparatus for providing ascent assistance and to a system for providing ascent assistance and further to a method for assisting a user in an ascent. The invention relates, in particular but not exclusively, to a climb assist device and to a method of assisting a user in an ascent or the like.

There are currently a number of commercially available systems that apply assistance to bodies climbing ladders and other structures. Within those known systems there are a number of different methods by which assistance is provided; however, generally they all aim to provide an element of haulage force or force to a rope or line in order to overcome some of the weight of the user. In effect, the “pull” applied to the rope or line acts to pull the body upwards with a force that is somewhat less than the weight of the body.

One of the disadvantages associated with these known systems is ensuring that a user doesn't inadvertently request too much assistance from the system thereby requesting assistance greater than the user's own weight. In this case, the system would lift the user with potentially unwelcome and dangerous consequences.

In an attempt to overcome this disadvantage, the systems generally limit the amount of assistance available from the system as a whole to an upper level of 40 to 50 kg i.e. less than the mass of the expected user. This safeguard, itself, has disadvantages in that, applying assistance of 50 kg to a user who, with tools and equipment, weighs 120 kg is of little assistance and, if a user is less than 50 kg in weight, the system still provides potentially dangerous levels of lifting assistance to such a user.

Other potential drawbacks associated with known technology are that these systems cannot be changed quickly to accommodate users of different weights without an operative or the user themselves returning to the control panel for the system. Furthermore, the known systems will not adapt the weight compensation they apply if the combined weight of a user changes in the course of usage due to tools and equipment being collected or deposited during the use of the system.

Another drawback is that the user must accurately know his/her mass plus any equipment they are carrying and be able to input it or the relevant amount of compensation into a system. Further still, the known system cannot compensate for misuse or user error in respect of the mass input into the system.

Further still, a user is forced to clip onto the system only when s/he needs to ascend. This is due to the fact that the system will always be actively attempting to pull the user, therefore, the user can only be attached to the system when s/he is ascending or stationary on the structure, i.e. when the assistance is either switched on or off. The systems of the prior art cannot, therefore, be used to safeguard the user if s/he steps off to one side of the structure as the device will either be locked or be attempting to pull him/her upwards.

It is an object of the present invention to overcome one or more of the drawbacks of known systems.

According to a first aspect, the present invention provides a load calibration device comprising;

a motive force generator;

a motive force applicator operably linked to the motive force generator;

and, in use of the load calibration device, an object to which the motive force applicator applies a motive force; and

a control mechanism having a load sensing means, and a haulage force application means; said control mechanism being formed and arranged so as to control the motive force generator in a first, calibration, mode wherein the motive force generator is stopped, and further wherein the load sensing means is formed and arranged to detect a load applied to the motive force applicator by the object and said haulage force application means is operable to determine an amount of haulage force to be applied to the motive force applicator by the motive force generator in accordance with the equation hf equals dl multiplied by a, where: “hf” equals haulage force in kg; “dl” equals detected load (load detected by the load sensing means) in kg and “a” equals applied assistance as a percentage.

In particularly preferred embodiments, the object comprises a user, including but not limited to a person and/or an animal. Alternatively or, in addition, the object may comprise equipment, tools or any other inanimate object whatsoever.

In embodiments of the first aspect, the motive force generator may comprise one or more of a powered winding reel, a hoist, a cable traction device, a capstan, a pulley, a counterweight device and/or a powered lifting device. The powered lifting device may be a scissor lift mechanism, for example. Thus, the motive force generator is operable to generate a force capable of acting on a further device and/or object.

In embodiments of the first aspect, the motive force applicator may comprise a rope. It will be readily understood that the term rope includes any type of line that is suitable for supporting a load. For example, the rope may be a rope of natural or synthetic fibres, a webbing tape, a steel wire or rope, a cable or the like. In such embodiments, the object is preferably attachable to the rope. Thus, the motive force applicator is linked to the motive force generator so as to derive a motive force therefrom which motive force may then be applied to an object by the applicator.

In embodiments wherein the motive force generator is a powered winding reel and the motive force applicator is a rope, the rope is preferably attached to the winding reel and, in use of the device, to an object.

In embodiments of the invention, the rope may be a continuous loop.

Alternatively, the rope is attached at one end to the motive force generator and, in use of the device, to an object a distal portion along the rope. In particular embodiments, the rope is attached at one end to the powered winding reel and, in use of the device, to an object, such as a user, a distal portion along the rope.

In alternative embodiments, the motive force applicator is a platform or the like. In such embodiments, the object is preferably locatable on the platform. In such embodiments, it will be understood that the motive force is applied to the object from below, i.e. the platform pushes the object rather than pulling same.

The object may be attached directly to the motive force applicator or, alternatively, may be indirectly attached to the motive force applicator.

In embodiments of the invention, the applied assistance “a” ranges from between 0% and 99%.

Although the applied assistance may be 99% in reality it is likely to be less than 99% because as the applied assistance approaches 99%, the object would be subject to some involuntary hauling. In embodiments wherein the object includes a user/person, such involuntary hauling would be undesirable as the person would be lifted without control over the lifting action.

In various embodiments, the applied assistance “a” may range from between 10% to 70%.

The haulage force may be of any magnitude. In embodiments wherein the object includes a person/user, the haulage force may be up to a maximum of 140 kg equivalent. By applying a maximum haulage force in cases wherein the object includes a person/user, the load calibration device is provided with a safety feature preventing a user from being subject to a potentially large, involuntary haulage force.

In alternative embodiments, it will be understood that the haulage force may be of a magnitude up to the safe working load of the load calibration device.

A determined haulage force of 0 kg would mean a load of 0 kg detected by the load sensing means or a preset assistance of 0%.

Haulage force will typically be measured in kgf or newtons according to the equation:

hf=dl×a

where:
hf=haulage force in kg
dl=detected load in kg
a=assistance as a percentage

Haulage force should be taken as including a “push” force as well as a “pull” force. That is to say, the haulage force may push a load upwards and/or may pull a load upwards.

The load may be the weight of a user and/or tools and/or equipment, or the like. It will be understood that any load may be applied to the motive force applicator in order to initiate the calibration mode. Further, the haulage force application means is operable to determine the amount of haulage force applicable to a load in response to the detection of that load by the load sensing means.

In embodiments of the invention, the haulage force application means is operable to determine an amount of haulage force to be applied to the motive force applicator by the motive force generator after the load has been detectable by the load sensing means for a preselected period.

More specifically, the preselected period may be 0 to 10 seconds, even more specifically may be 1 to 5 seconds and is, preferably 3 to 4 seconds. In this way, the calibration mode will not be inadvertently activated when an object, such as a user, is associated with the motive force applicator of the calibration device and will, instead, require an active intervention on the part of the operator or user. In particular embodiments, the preselected period of delay ensures that the calibration mode will not be inadvertently activated when an object, such as a user, is clipped onto the rope of the calibration device and will, instead, require an active intervention on the part of the operator or user.

In embodiments of the invention, a signal may be communicated to the operator or user to signal the successful calibration of the device.

The signal may be an audible signal, for example. Alternatively or, in addition, the signal may comprise a visible signal or a tactile signal. The visible signal may be a light, for example. The tactile signal may be a vibration applied through the rope.

According to a second aspect the present invention provides an apparatus for providing ascent assistance comprising:

a motive force generator;

a motive force applicator operably linked to the motive force generator;

and, in use of the apparatus, an object to which the motive force applicator applies a motive force; and

a control mechanism comprising a load sensing means and a haulage force application means; said control mechanism being formed and arranged so as to control the motive force generator in a first, calibration, mode wherein the motive force generator is stopped, and further wherein the load sensing means is formed and arranged to detect a load applied to motive force applicator by the object and said haulage force application means is operable to determine an amount of haulage force to be applied to the motive force applicator by the motive force generator in accordance with the equation hf equals dl multiplied by a, where: “hf” equals haulage force in kg; “dl” equals detected load (load detected by the load sensing means) in kg and “a” equals applied assistance as a percentage; the control mechanism being operable to switch the operation of the motive force generator into a second, assisted ascent mode wherein the motive force generator initially acts upon the motive force applicator until the load detected by the load sensing means is substantially equal to the weight of the motive force applicator, and said haulage force application means is operable to apply said determined haulage force to the motive force applicator by way of the motive force generator, which haulage force acts upon the motive force applicator in opposition to the load.

In particularly preferred embodiments, the object comprises a user, including but not limited to a person and/or an animal. Alternatively or, in addition, the object may comprise equipment, tools or any other inanimate object whatsoever.

In embodiments of the second aspect, the motive force generator may comprise one or more of a powered winding reel, a hoist, a cable traction device, a capstan, a pulley, a counterweight device and/or a powered lifting device. The powered lifting device may be a scissor lift mechanism, for example. Thus, the motive force generator is operable to generate a force capable of acting on a further device and/or object.

In embodiments of the second aspect, the motive force applicator may comprise a rope. It will be readily understood that the term rope includes any type of line that is suitable for supporting a load. For example, the rope may be a rope of natural or synthetic fibres, a webbing tape, a steel wire or rope, a cable or the like. In such embodiments, the object is preferably attachable to the rope. Thus, the motive force applicator is linked to the motive force generator so as to derive a motive force therefrom which motive force may then be applied to an object by the applicator.

In embodiments wherein the motive force generator is a powered winding reel and the motive force applicator is a rope, the rope is preferably attached to the winding reel and, in use of the device, to an object.

In embodiments of the invention, the rope may be a continuous loop.

Alternatively, the rope is attached at one end to the motive force generator and, in use of the device, to an object a distal portion along the rope. In particular embodiments, the rope is attached at one end to the powered winding reel and, in use of the device, to an object, such as a user, a distal portion along the rope.

In alternative embodiments, the motive force applicator is a platform or the like. In such embodiments, the object is preferably locatable on the platform. In such embodiments, it will be understood that the motive force is applied to the object from below, i.e. the platform pushes the object rather than pulling same.

The object may be attached directly to the motive force applicator or, alternatively, may be indirectly attached to the motive force applicator.

In preferred embodiments, the apparatus is an apparatus for providing climb assistance. In such embodiments, the object will include a user.

In particularly preferred embodiments, the apparatus for providing climb assistance comprises:

a powered winding reel;

a rope attached to the winding reel and, in use of the device, to a user; and

a control mechanism comprising a load sensing means and a haulage force application means; said control mechanism being formed and arranged so as to control the powered winding reel in a first, calibration, mode wherein the winding reel is stopped, and further wherein the load sensing means is formed and arranged to detect a load applied to the rope and said haulage force application means is operable to determine an amount of haulage force to be applied to the rope by the winding reel, said haulage force being determined in accordance with the equation hf equals dl multiplied by a, where: “hf” equals haulage force in kg; “dl” equals detected load (load detected by the load sensing means) in kg and “a” equals applied assistance as a percentage;

the control mechanism being operable to switch the operation of the winding reel into a second, assisted climb, mode wherein the winding reel operates to prevent slack in the rope between said user in use of the device and said winding reel, and said haulage force application means is operable to apply a haulage force to the rope by way of the winding reel, which haulage force provides climb assistance to the user at the determined force.

In embodiments of the invention, the applied assistance “a” ranges from between 0% and 99%.

Although the applied assistance may be 99% in reality it is likely to be less than 99% because as the applied assistance approaches 99%, the object would be subject to some involuntary hauling. In embodiments wherein the object includes a user/person, such involuntary hauling would be undesirable as the person would be lifted without control over the lifting action.

In various embodiments, the applied assistance “a” may range from between 10% to 70%.

The haulage force may be of any magnitude. In embodiments wherein the object includes a person/user, the haulage force may be up to a maximum of 140 kg equivalent. By applying a maximum haulage force in cases wherein the object includes a person/user, the apparatus is provided with a safety feature preventing a user from being subject to a large, involuntary haulage force.

In alternative embodiments, it will be understood that the haulage force may be of a magnitude up to the safe working load of the apparatus.

A determined haulage force of 0 kg would mean a load of 0 kg detected by the load sensing means or a preset assistance of 0%. Thus, when the haulage force is 0 kg, the apparatus for providing ascent assistance will provide an unassisted ascent to the object. Such embodiments would provide a user with an unassisted climb, for example.

Haulage force will typically be measured in kgf or newtons according to the equation:

hf=dl×a

where:
hf=haulage force in kg
dl=detected load in kg
a=assistance as a percentage

As is also the case with the first aspect, in the second aspect, haulage force should be taken as including a “push” force as well as a “pull” force. That is to say, the haulage force may push a load upwards and/or may pull a load upwards.

The load may be the weight of a user and/or tools and/or equipment, or the like. It will be understood that any load may be applied to the rope in order to initiate the calibration mode.

In embodiments of the second aspect, the haulage force application means is operable to determine the amount of haulage force applicable to a load in response to the detection of that load by the load sensing means.

In alternative embodiments, the first, calibration mode is preceded by a pre-calibration mode in which the control mechanism is formed and arranged so as to control the motive force generator to equalise the force differential with the object until the load sensing means detects a constant load for a predetermined time. Thereafter, the first, calibration mode is initiated.

When a haulage force is applied to the motive force applicator by the motive force generator, the object is assisted in an ascent without being moved involuntarily because the haulage force will always be insufficient to move the object on its own.

In this way, the level of assistance provided to the object by the motive force generator is sufficient to reduce the effective load on the motive force applicator in the second, assisted ascent, mode to approaching zero kilograms whilst ensuring that the level of assistance is always relative to the actual load detected on the motive force applicator during the calibration mode.

The load may be the weight of a user and/or tools and/or equipment, or the like. It will be understood that any weight may be applied to the motive force applicator in order to initiate the calibration mode.

In embodiments of the invention, in the first, calibration, mode the haulage force application means is operable to determine an amount of haulage force to be applied to the motive force applicator by the motive force generator after the load has been detectable by the load sensing means for a preselected period.

More specifically, the preselected period may be 0 to 10 seconds, even more specifically may be 1 to 5 seconds and is, preferably 3 to 4 seconds. In this way, the calibration mode will not be inadvertently activated when an object, such as a user, is associated with the motive force applicator of the apparatus and will, instead, require an active intervention on the part of the operator or user. The active intervention may take the form of a user applying their weight to the device or instructing the device to take in rope, for example.

In particular embodiments, the preselected period of delay ensures that the calibration mode will not be inadvertently activated when an object, such as a user, is clipped onto the rope of the calibration device and will, instead, require an active intervention on the part of the operator or user.

In embodiments of the invention, a signal may be communicated to the operator or user to signal the successful calibration of the device.

The signal may be an audible signal, for example. Alternatively or, in addition, the signal may comprise a visible signal or a tactile signal. The visible signal may be a light, for example. The tactile signal may be a vibration applied through the rope.

In embodiments of the invention, when the apparatus for providing ascent assistance is in the second, assisted ascent, mode the load sensing means is preferably operable to detect a change in the load on the motive force applicator.

When the apparatus for providing ascent assistance is in the second, assisted ascent, mode and the load sensing means detects a change in the load on the motive force applicator, the control mechanism is operable to switch the operation of the motive force generator to a third, unassisted ascent, mode wherein the motive force generator initially acts upon the motive force applicator until the load detected by the load sensing means is substantially equal to the weight of the motive force applicator and wherein the haulage force application means ceases to apply the haulage force to the motive force applicator by way of the motive force generator.

In exemplary embodiments, therefore, when the apparatus for providing ascent assistance is in the second, assisted ascent, mode and the load sensing means detects a change in the load on the rope, the control mechanism is operable to switch the operation of the powered winding reel to a third, unassisted ascent, mode wherein the winding reel operates to prevent slack in the rope between the object in use of the device and the winding reel and wherein the haulage force application means ceases to apply the haulage force to the rope by way of the winding reel.

In embodiments of the invention, wherein the apparatus for providing ascent assistance is a climb assistance apparatus, the change in load may be due to a user picking up and/or dropping off tools and/or equipment. Alternatively, or in addition, the change in load may be due to a change in the user of the apparatus for providing climb assistance. The apparatus for providing climb assistance will cease to provide assisted ascent to a user if there is a change in the load detected by the load sensing means whilst the device is in the second, assisted climb, mode.

Alternatively or, in addition, the apparatus for providing climb assistance will cease to provide assisted ascent to a user whilst in the second, assisted climb mode, if the control mechanism detects no activity on the rope for a predetermined time. In such embodiments, “no activity” means that the user is not moving forwards or backwards, up or down. In embodiments, the predetermined time may be 2 to 3 seconds, for example.

Alternatively, when the apparatus for providing ascent assistance is in the second, assisted ascent, mode and the load sensing means detects a load substantially equal to the load detected by the load sensing means in the first, calibration, mode on the motive force applicator, the control mechanism is operable to switch the operation of the motive force generator to a fourth, fall or descent mode, wherein the motive force generator is stopped and the haulage force application means ceases to apply the haulage force to the motive force applicator by way of the motive force generator and the user is maintained in position by the motive force applicator.

In particular embodiments, the apparatus is an apparatus for providing climb assistance. When the apparatus for providing climb assistance is in the second, assisted climb, mode and the load sensing means detects a load substantially equal to the load detected by the load sensing means in the first, calibration, mode on the rope, the control mechanism is operable to switch the operation of the winding reel to a fourth, fall or descent mode, wherein the winding reel is stopped and the haulage force application means ceases to apply the haulage force to the rope by way of the winding reel and the user is suspended by the rope.

As a further alternative, when the apparatus for providing ascent assistance is in the second, assisted ascent, mode and the load sensing means detects a load substantially equal to the load detected by the load sensing means in the first, calibration, mode on the motive force applicator, the haulage force application means may be operable to reduce the applied assistance and, therefore, the haulage force to approaching 0%. It will be understood that a haulage force approaching 0 kg means a haulage force capable of lifting the weight of the motive force applicator and overcoming any friction in the system will be required.

In this way, the object, such as a user, is at all times protected against a fall or other involuntary descent.

When the ascent assistance in the form of the haulage force is removed, that is to say that the second, assisted ascent, mode is de-activated, a user must repeat the first, calibration, mode in order to re-activate the second, assisted ascent, mode.

Alternatively, the user may proceed unassisted. More specifically the control mechanism is operable to switch the motive force generator into a third, unassisted ascent, mode wherein the motive force generator is initially operable to act upon the motive force applicator until the load detected by the load sensing means is substantially equal to the weight of the motive force applicator and the haulage force application means provides no haulage force to the motive force applicator by way of the motive force generator. That is to say the haulage force application means is operable to apply a haulage force capable of lifting the weight of the motive force applicator and overcoming any friction in the system.

It will be apparent that the haulage force applied in the third, unassisted ascent, mode will be 0 kg and that the haulage force application means is inactive in the third mode unless the first, calibration, mode is initiated by the user.

Further, at any time a user may choose to operate the apparatus in the third, unassisted ascent, mode. In this way, a user may associate themselves with the motive force applicator, such as clip onto the rope of the apparatus, and may move backwards and forwards at floor level or at any intermediate horizontal level and/or up and down without restriction. Should the user then choose to ascend from his/her position, the apparatus will operate in the third, unassisted ascent, mode thereby providing fall prevent protection as s/he ascends. The apparatus will initiate the assisted ascent mode only when the user has successfully completed the first, calibration, mode.

When the apparatus for providing ascent assistance is in the third, unassisted ascent, mode and the load sensing means detects a load substantially equal to the load detected by the load sensing means in the first, calibration, mode on the motive force applicator, the control mechanism is operable to switch the operation of the motive force generator to a fourth, fall or descent mode, wherein the motive force generator is stopped and the haulage force application means applies no haulage force to the motive force applicator by way of the motive force generator and the user is maintained in position by the motive force applicator.

In this way, the user is at all times protected against a fall or other involuntary descent.

Following a fall, the apparatus may, after a preselected period, switch to the first, calibration, mode. This is due to the fall simulating the calibration steps. The user may de-activate the calibration mode and descend to the floor or other intermediate horizontal level.

De-activation of the calibration mode may be by remote control, for example.

Alternatively, following a fall, the control mechanism may be operable to switch the operation of the motive force generator to a fifth mode wherein the operation of the motive force generator is reversed and the user may descend to a safe position.

In various embodiments following a fall, the fifth mode is initiated following a predetermined period. More specifically, the predetermined period may be between 1 and 10 seconds.

At any time, the first, calibration, mode may be initiated by a user by putting a load onto the load sensing device. This can be done at floor level (or any intermediate horizontal level) by the user sitting back onto the rope, for example, and raising his/her feet off the floor. Alternatively, the user may ascend a few steps from their position before falling back onto the rope, for example.

The apparatus for providing ascent assistance may also be configured to detect a stop or pause in the movement of the user. The control mechanism, in detecting a pause or a stop in the movement of the user, is operable to switch the operation of the motive force generator to the third, unassisted ascent, mode, wherein the motive force generator initially acts upon the motive force applicator until the load detected by the load sensing means is substantially equal to the weight of the motive force applicator and the haulage force application means ceases to apply the haulage force to the motive force applicator by way of the motive force generator.

When the ascent assistance in the form of the haulage force is removed, the user must repeat the first, calibration, mode in order to re-activate the second, assisted ascent, mode. Alternatively, the user may proceed in a further, un-assisted ascent, mode, wherein the control mechanism is operable to switch the motive force generator into a third, unassisted ascent, mode wherein the motive force generator initially acts upon the motive force applicator until the load detected by the load sensing means is substantially equal to the weight of the motive force applicator. It will be apparent that the haulage force applied in the third, unassisted ascent, mode will be 0 kg and that the applied assistance “a” will be 0%.

Alternatively, the haulage force application means is inactive in the fourth mode.

According to a third aspect, the present invention further provides a system for providing ascent assistance comprising:

a motive force generator;

a motive force applicator operably linked to the motive force generator and, in use of the system, an object to which the motive force applicator applies a motive force; and a control mechanism comprising load sensing means, an electronic control and diagnostic system, and a haulage force application means;

said control mechanism being formed and arranged so as to control the motive force generator in a first, calibration, mode wherein the motive force generator is stopped, and further wherein the load sensing means is formed and arranged to detect a load applied to the motive force applicator and said haulage force application means is operable to determine an amount of haulage force to be applied to the motive force applicator by the motive force generator, in accordance with the equation hf equals dl multiplied by a, where: “hf” equals haulage force in kg; “dl” equals detected load (load detected by the load sensing means) in kg and “a” equals applied assistance as a percentage; the control mechanism being operable to switch the operation of the motive force generator into a second, assisted ascent, mode wherein the motive force generator initially acts upon the motive force applicator until the load detected by the load sensing means is substantially equal to the weight of the motive force applicator, and said haulage force application means is operable to apply said determined haulage force to the motive force applicator by way of the motive force generator, which haulage force provides ascent assistance to the object; in operation of the second, assisted ascent, mode the load sensing means is formed and arranged to detect the weight of a said object on the motive force applicator, and to switch the operation of the motive force generator to a fourth, fall or descent mode, wherein the motive force generator is stopped and a said object is maintained in position by the motive force applicator, and the electronic control and diagnostic system is formed and arranged to monitor the operation of the motive force generator and the control mechanism, and to switch the operation of the motive force generator to a fifth, fault mode, when a fault is detected.

In particularly preferred embodiments, the object comprises a user, including but not limited to a person and/or an animal. Alternatively or, in addition, the object may comprise equipment, tools or any other inanimate object whatsoever.

In embodiments of the third aspect, the motive force generator may comprise one or more of a powered winding reel, a hoist, a cable traction device, a capstan, a pulley, a counterweight device and/or a powered lifting device. The powered lifting device may be a scissor lift mechanism, for example. Thus, the motive force generator is operable to generate a force cable of moving a further device and/or object.

In embodiments of the third aspect, the motive force applicator may comprise a rope. It will be readily understood that the term rope includes any type of line that is suitable for supporting a load. For example, the rope may be a rope of natural or synthetic fibres, a webbing tape, a steel wire or rope, a cable or the like. In such embodiments, the object is preferably attachable to the rope. Thus, the motive force applicator is linked to the motive force generator so as to derive a motive force therefrom which motive force may then be applied to an object by the applicator.

In embodiments wherein the motive force generator is a powered winding reel and the motive force applicator is a rope, the rope is preferably attached to the winding reel and, in use of the system, to an object.

In particular embodiments, the system is a system for providing climb assistance. More specifically, the system for providing climb assistance comprises:

a powered winding reel;

a rope attached to the winding reel and, in use of the device, to a user;

and a control mechanism comprising load sensing means, an electronic control and diagnostic system, and a haulage force application means;

said control mechanism being formed and arranged so as to control the powered winding reel in a first, calibration, mode wherein the winding reel is stopped, and further wherein the load sensing means is formed and arranged to detect a load applied to the rope and said haulage force application means is operable to determine an amount of haulage force to be applied to the rope by the winding reel, in accordance with the equation hf equals dl multiplied by a, where: “hf” equals haulage force in kg; “dl” equals detected load (load detected by the load sensing means) in kg and “a” equals applied assistance as a percentage; the control mechanism being operable to switch the operation of the winding reel into a second, assisted climb, mode wherein the winding reel operates to prevent slack in the rope between said user in use of the device and said winding reel, and said haulage force application means is operable to apply said determined haulage force to the rope by way of the winding reel, which haulage force provides climb assistance to the user; in operation of the second, assisted climb, mode the load sensing means is formed and arranged to detect the weight of a said user on the rope, and to switch the operation of the winding reel to a fourth, fall or descent mode, wherein the winding reel is stopped and a said user is suspended by the rope, and the electronic control and diagnostic system is formed and arranged to monitor the operation of the powered winding reel and the control mechanism, and to switch the operation of the winding reel to a fifth, fault mode, when a fault is detected.

In certain embodiments, when the load sensing detects the weight of a said object on the motive force applicator, rather than initiating the fourth, fall or descent mode, the load sensing means may be formed and arranged to detect a load substantially equal to the load detected by the load sensing means in the first, calibration, mode on the motive force applicator, and to switch the operation of the motive force generator to a third, unassisted ascent, mode wherein the motive force generator initially acts upon the motive force applicator until the load detected by the load sensing means is substantially equal to the weight of the motive force applicator and wherein the haulage force application means ceases to apply the haulage force to the motive force applicator by way of the motive force generator.

In various embodiments, in this way the user is kept on a taught rope which prevents the fall as in the third, unassisted ascent, mode, the motive force generator operates to prevent slack in the rope between the object in use of the device and the motive force generator and wherein the haulage force application means ceases to apply the haulage force to the motive force applicator by way of the motive force generator.

Alternatively, when the load sensing detects the weight of a said object on the motive force applicator, rather than initiating the fourth, fall or descent mode, the load sensing means may be formed and arranged to detect a load substantially equal to the load detected by the load sensing means in the first, calibration, mode on the motive force applicator, and to act upon the haulage force application means which is then operable to reduce the applied assistance “a” to approaching 0% to the motive force applicator, thereby, effectively reducing the applied haulage force to 0 kg whilst remaining in the second, assisted ascent, mode.

Following detection of a fault and initiation of the fifth, fault, mode, a reset of the system may be required for further operation.

According to a fourth aspect, the present invention provides, a method for assisting a user in an ascent when working at height, the method comprising the steps of:

providing a rope;

detecting a load applied to the rope in a first direction;

selecting a level of applied assistance to be provided to the user;

determining a haulage force in accordance with the equation hf equals dl multiplied by a, where: “hf” equals haulage force in kg; “dl” equals detected load (load detected by the load sensing means) in kg and “a” equals applied assistance as a percentage;

applying the haulage force in a second direction to counterweight against the load applied to the rope in the first direction.

The method may further comprise one or more of the steps of: signalling to a user on the rope that the haulage force has been determined; providing a preselected time delay between the steps of determining a haulage force as a percentage of the load detected on the rope and that of applying the haulage force to counterweight against the load applied to the rope; removing the haulage force in response to a change in the load detecting on the rope.

Hereinafter various embodiments of the invention will be described. The features of the embodiments now described may be features of the first, second, third and/or the fourth aspects of the present invention. The various embodiments are described with particular reference to climb assistance although it will be readily understood upon reading the present disclosure, that the embodiments are applicable to any ascent and/or descent by an object, such as a user/person.

Preferably, the motive force generator may be powered manually, automatically or by any other suitable means whatsoever.

In various embodiments, it is preferred that the motive force generator is powered by an electric motor or the like. Alternatively, the motive force generator may be powered manually or by other automated powering means.

In particular embodiments, the motive force generator is a winding reel which is powered by an electric motor or the like.

Alternatively, the winding reel may be powered manually or by other automated powering means.

In embodiments of the invention, in the second, assisted ascent, mode and/or the third, unassisted ascent, mode, the control mechanism directs the motive force generator to act upon the motive force applicator until the load detected by the load sensing means is substantially equal to the weight of the motive force applicator.

In embodiments of the third aspect of the present invention in particular, the control mechanism may act via the electronic control and diagnostic system to direct the motive force generator initially to act upon the motive force applicator until the load detected by the load sensing means is substantially equal to the weight of the motive force applicator.

In the third, unassisted ascent, mode, when the load detected by the load sensing means is substantially equal to the weight of the motive force applicator, the motive force generator is directed to stop. In the second, assisted ascent, mode, when the load detected by the load sensing means is substantially equal to the weight of the motive force applicator, the motive force generator is initially directed to stop, however, the haulage force application means continues to apply haulage force to the motive force applicator via the motive force generator.

More specifically, in embodiments of the invention, in the second, assisted ascent, mode and/or the third, unassisted ascent, mode, the control mechanism acts to prevent slack in the rope by directing the winding reel, to wind in the rope when slack is detected.

In embodiments of the third aspect of the present invention in particular, the control mechanism may act to prevent slack in the rope by directing the winding reel, via the electronic control and diagnostic system, to wind in the rope when slack is detected. In certain embodiments, the electronic control and diagnostic system may be configured to detect when slack in the rope is being created at the direction of the user attempting to manually unwind the rope without a load applied thereto. In such embodiments, the rope may be unwound by the user to a predetermined point when the slack is detected by the system.

In various embodiments, the electronic control and diagnostic system may be configured to prevent the winding reel from taking in rope when a load below a threshold value is detected for a predetermined time. Thus, if a load below a certain threshold is measured the system would only take in rope for a short period preventing the rope from being lifted away from the user in the event that they forget to clip it to something after use. This may also be detected by the smoothness of the take in of the rope. If the system detects a uniform take in load over a period of time, not representative of a human climbing, then the take in of the rope by the winding reel would be stopped after the predetermined time.

In the third, unassisted ascent, mode, when, the slack is removed the winding reel is directed to stop. In the second, assisted ascent, mode, when, the slack is removed the winding reel is directed to stop, however, the haulage force application means continues to apply haulage force to the rope via the winding reel.

When a light tension is applied to the rope, for example when a user descends in a controlled fashion, the winding reel may be directed to pay out rope. In fall or descent mode, where the weight of the user is applied to the rope the winding reel is directed to stop. Then unwinding of the rope to lower the user to the ground can be initiated, in a number of ways as discussed hereafter. In fault mode the winding reel is stopped and an alarm is signalled.

In the fault mode, the apparatus and system of the invention will stop the winding reel until the fault is cleared or overridden.

A ‘limp home mode’ will be invoked where a non-fatal error is detected for example when sensors fail to agree, power is lost and UPS switches on etc. This limp home mode disables all advanced functions (climb assist etc) and sounds all warnings telling the user to return to a safe level and check system.

When present, the electronic control and diagnostic system takes inputs from the rest of the control mechanism including sensors.

In various embodiments, in response to the inputs from the rest of the control mechanism, the electronic and diagnostic system controls the powering of the winding reel. Typically the winding reel is powered by a three-phase electric motor and the electronic control and diagnostic system controls an inverter, which in turn controls the speed and direction of the motor, and hence of the winding reel. At the same time the electronic control and diagnostic system performs the diagnostic function. The diagnostic function can operate on a number of levels. The outputs from the control system including sensors, such as, for example, micro switches or potentiometers as described hereafter, can be compared with each other and any discrepancy initiates the fault mode. Similarly the signal inputs to the inverter can be compared with the output signals to initiate the fault mode. Other sensors may also be employed and used to input the diagnostic system, for example detecting the motion of the winding reel independently, or additional, ‘redundant’ sensors may be employed in the control mechanism for cross checking purposes. The diagnostic function provides essential additional safety in the operation of a apparatus for providing climb assistance . Although the risk of a malfunction of the control system the control system may be small, the consequences could be serious, potentially resulting in severe injury or even death to a user. For example if the winding reel pays out rope uncontrollably due to a fault, a user could be left without protection, at a dangerous height. It is considered that a apparatus for providing climb assistance of the invention without an appropriate self diagnostic system would be unlikely to be given regulatory approval, such as CE approval for use.

Preferably the electronic control and diagnostic system is programmable.

Preferably the inverter used to control the speed and direction of the winding reel is also programmable. The electronic programmable control system and inverter allows a wide range of functionality to be built into the control system and operational control of the speed and direction of the winding reel can be almost infinite. This allows the operation of the apparatus for providing ascent assistance and system of the invention to be altered to suit the conditions and the type of use required as discussed hereafter, by simply reprogramming the electronic control and diagnostic system.

It will be readily understood by the reader that the term rope includes any type of line that is suitable for supporting the weight of a user in the event of a fall. For example, the rope may be a rope of natural or synthetic fibres, a webbing tape or a steel wire or rope. Advantageously the calibration device, the apparatus for providing ascent assistance and the system for providing ascent assistance of the present invention can each and all be used with a conventional climbing rope, so that the climbing experience provided closely simulates that of climbing with a partner using such ropes.

The control mechanism can be constructed or programmed so that, in the assisted and unassisted ascent modes, the winding reel winds the rope in whenever there is slack in the rope and will also unwind to pay out rope when under light tension i.e. less than the weight of a user. This arrangement keeps the rope properly taut at all times during either top rope or lead climbing operations, for example, whilst allowing a user to obtain more rope if required for manoeuvring.

However, for added safety, especially when being used by inexperienced users, it may be preferable that the operation of the winding reel be more restricted. For example in top rope climbing the assisted and unassisted ascent modes may only act to wind the rope in when it is slack and then simply stop when the slack is taken up i.e. the rope does not unwind when under light tension. This method of operation prevents a user pulling out a quantity of free rope from the winding reel. This would result in the user being inadequately protected in the event of a fall.

For safety reasons, in embodiments of the invention where the control mechanism operates the winding reel in a different fashion for either top rope or lead climbing, for example, the apparatus for providing ascent assistance is preferably further provided with security means such as a lock and key or electronic code lock, which prevents operation in a manner inappropriate to the climbing method (top rope or lead) being attempted.

When a length of rope has been pulled from the winding reel and is not being held taut in a climbing situation, it has to be wound back onto the winding reel for next use. In such circumstances it has been found that the rope may coil loosely onto the drum unless some tension is applied to the rope as it is wound in. Such loose coils can catch on the mechanism of the apparatus for providing ascent assistance and impair its correct and safe operation. Therefore the apparatus for providing ascent assistance of the invention may optionally be fitted with a nip roller mechanism, formed and arranged to apply tension between a rope being wound onto the winding reel and the winding reel. The nip roller mechanism only operates when a special, rewinding mode is selected, to avoid interference with the normal operation of the control mechanism, which depends on rope tension. The nip roller arrangement also helps to direct or ‘tail’ the rope onto the winding reel in a regular layered fashion.

Where required, for example, where a very long length of rope, especially a thin rope such as a steel cable, is being used with a apparatus for providing ascent assistance of the invention, then a self-tailing mechanism may be fitted to provide improved control of the layering of the rope onto the winding reel. Self-tailing devices are well known in winding operations for long lengths of cable or rope. For example a self tailing device may comprise a guide, tensioning the rope, which moves back and forth the across the width of the winding reel as the rope is wound in, to direct the placement or the coils of rope as they are wound onto the reel.

The operation of the apparatus for providing ascent assistance of the invention ensures that the line is kept taut. In top rope climbing the control mechanism switches on the motor of the winding reel to wind in the rope whenever it is slack i.e. not under tension. This effectively simulates the situation in which a user is attended by a partner who keeps the rope taut to ensure that, in the event of a fall, the user does not fall freely for any substantial distance before being brought under control by the device. In the event of a fall the control mechanism of the invention switches to fall mode and operates to stop the operation of the winding reel.

Where the winding reel is driven by a motor acting directly through a gearbox then depending on the motor and the gearbox ratios used in the drive train, the fallen user will either be suspended from the rope close to the point where they fell or their weight will be sufficient to turn the winding reel, gearbox and motor, gradually lowering the user towards the ground. Preferably a drive train is selected which holds a user in position, close to the point where they fell. Fallen users can then simply carry on climbing, re-attach themselves to the climbing surface to continue the climb or they can activate the lowering sequence by a remote control device, as described below, to lower themselves to the ground with the winding reel operating under power. It can be readily appreciated that the rope should not unwind from the reel when the user is climbing up the climbing surface or is stationary, standing on or holding onto the climbing surface. This would lead to a situation where the rope is slack and the user would not be properly protected in the event of a fall. Accordingly in normal use the control mechanism only allows descent when the weight of the user tensions the line.

Advantageously, the control mechanism of the invention further comprises a timer mechanism which, when an adjustable period of time has elapsed, will automatically activate the lowering sequence to lower a user safely to the ground when the weight of a user tensions the rope.

This automatic lowering of a user, who tensions the rope with their weight, after a set period of time is particularly useful when children or novices are learning to climb. They do not have to operate a remote control to descend once they have spent some time attempting the climb. As the rate of descent is slow and controlled, they can, if they wish reattach themselves to the climbing surface without comprising safety. The lowering sequence ceases immediately the weight of the user no longer tensions the rope and the control mechanism then operates as normal to keep the rope taut. If desired the time period can be set to zero so that lowering occurs whenever the weight of a user tensions the rope.

Preferably the apparatus for providing ascent assistance of the invention includes a remote control device for initiating the operation of the apparatus for providing ascent assistance in its first, second or third modes and signalling the control mechanism to unwind the rope for descent when in its fourth mode. Preferably the remote control device is a wireless remote control. A duplicate remote control, which may be wireless or wired, may also be supplied to allow an assistant to operate the system if required, for example in an emergency. A remote control is conveniently carried by the user, attached to their equipment or clothing. This avoids the requirement for a partner or assistant at any stage of the ascent. The remote control can be programmed to allow a user to stop during descent. This facility allows users to reattach themselves at a chosen point on a wall to restart an ascent. It is also useful in industrial situations where positioning at a precise point on a structure is required.

It will be appreciated that in some circumstances, for example during maintenance of an artificial climbing surface, it will be beneficial if the winding reel can be operated to act as a lifting device to raise a person engaged in maintenance work. In these circumstances the haulage force may be greater than 100%. For such circumstances the normal ‘fail safe’ operation of the winding reel can be overridden, for example by entering a key or a key code to the remote control device, which allows access to an optional lifting mode of the control mechanism which allows winding in under load (tension), by the apparatus for providing ascent assistance of the invention. Using a apparatus for providing ascent assistance of the invention as a lifting device can also be beneficial in many industrial situations. With an appropriately powered winding reel (with sufficient torque) a apparatus for providing ascent assistance of the invention can be used to lift dead weights, such as building materials, whilst another device is used to support a user who is going to use the materials. Similarly a user can be directly lifted into position if required by using a device of the invention. For safety reasons, when a user is being lifted it is preferred that two ropes are used. Preferably where two ropes are employed the winding reel of the apparatus for providing ascent assistance is partitioned into two winding sections. Each winding section can then be loaded with a separate rope. By this means both the ropes are operated together by a single apparatus for providing ascent assistance. Alternatively two apparatus of the invention can be used, each with a rope connected to the user being lifted. Where two apparatus are used, they can be located at each corner of the face of a building. This has the benefit of allowing a “user” to be lifted to any position across the height and width of the face of the building by controlling the amount of rope wound in on each of the two spaced apart winding reels.

To discourage misuse and lifting people over long distances (and potentially into dangerous situations) the hoist function as applied to people is restricted so that it will only hoist in bursts or pulses (typically 1 second). It can then be used to right somebody in an emergency but would be inconvenient to use over any distance.

In use in a commercial climbing facility, the remote control system can also be provided with a timer mechanism, which allows use of the apparatus for providing ascent assistance to be purchased on a ‘by time’ basis. Alternatively or, in addition, the control mechanism may itself be provided with a timer mechanism, which allows use of the apparatus for providing ascent assistance to be purchased on a ‘by time’ basis.

Although when used for top rope climbing the apparatus for providing ascent assistance can be positioned at the top of a climb with the rope hanging down it can more conveniently be placed on the ground or at an intermediate height. The winding reel is then used for top rope climbing by running the rope up and over a pulley situated at the top of the climb. Positioning the winding reel at the foot of a climb allows easy access for maintenance and also allows the apparatus for providing ascent assistance of the invention to be used for lead climbing. In some situations, for example, where the apparatus for providing ascent assistance is being used to provide safety to a user who is working on the outside of a building, the apparatus for providing ascent assistance may be mounted so as to be moveable along a track or runway. This arrangement can also be used in a sport climbing facility where the apparatus for providing ascent assistance, in use for top rope climbing, can be located on a track that runs along the top edge of a climbing wall or structure.

The apparatus for providing ascent assistance can be moved as desired to a chosen location.

Mounting the apparatus for providing ascent assistance on a track or runway allows it to be moved easily, on wheels running on rails for example, along a pre-determined route, such as along the top edge of a building. This allows access to any part of the face of the building when using the apparatus for providing ascent assistance. The movement of the device along the track may be remotely controlled if desired. If it is required that an user move along a pre-determined course, perhaps with varying height, then the apparatus for providing ascent assistance can be programmed to move along the track and wind in or out the rope to conform to the required course. For other applications, such as tree surgery, maintenance of wind turbines or the like, or steeplejack work, a apparatus for providing ascent assistance of the invention may be mounted conveniently on a truck or other vehicle for mobility.

When being used for lead climbing the rope is kept taut, only unwinding when the user climbs and some tension is applied to the rope. If the user should fall, the control mechanism switches the winding reel to fall or descent mode and then the user will immediately be suspended by the rope from the highest securing means used and then can be lowered to the ground at a pre-determined (safe) rate in similar fashion to that of the top rope climbing. In lead climbing it is particularly important that the control of the tension in the rope and the winding in and winding out operations of the reel are carefully controlled. Unlike with top rope climbing the control mechanism must allow a user to pull out some rope from the winding reel, in order to allow a portion of rope to be lifted for attachment to the next anchoring point (such as a temporary or permanent ring bolt or a quick draw) as the user climbs. This process of “pulling out” a length of rope must be undertaken quickly, at approximately double the speed of the normal operation of the device. However the process of pulling the rope out must not trigger the override switch mechanism, which could cause the rope to be unwound further or stop the winding reel operating. Similarly when the rope has been clipped into the next anchoring point the device must act to wind back in any excess of rope to return to the desired taut rope situation. Testing has shown that the fine control required for optimum safety and operation when lead climbing is achieved with electronic control system described earlier.

The control mechanism may comprise a pivot formed and arranged so that, in use of said apparatus for providing ascent assistance, said powered winding reel rests in a first position when said rope is not under tension and moves about said pivot to a second position when said rope is under tension; at least one switch for controlling the powering of said winding reel, said switch being, in use of the apparatus for providing ascent assistance, operable when the powered winding reel moves between said first and second positions; and, an override switch mechanism, said override switch mechanism being formed and arranged so that, in use of said apparatus for providing ascent assistance, said override switch mechanism is actuated when said rope in under a tension substantially equal to or greater then the weight of a user attached to said rope, and can allow the winding reel to unwind the rope.

Preferably the pivot rotates the powered winding reel about a horizontal axis. Desirably the pivot is located near but not at the balance point for the reel and its associated motor. The winding reel then rests tilted from the horizontal, usually with one end resting on a base support (or the ground). When tension is applied to the rope the reel tilts from the first to the second position, moving back to the first position, under gravity, when the rope slackens.

It will be appreciated that other embodiments of the control mechanism of the invention can be envisaged. For example, where the pivot rotates the reel about a vertical axis when the rope is under tension. In such a case the reel is returned to its first position by the action of a resilient biasing member such as a spring, when the rope is no longer under tension.

The switch or switches for controlling the operation of the reel can be micro-switches located at a point of contact between an end of the reel and a base support or the ground. As the reel tilts the micro-switch operates when under pressure from the reel contacting the ground or support. Alternative switches such as tilt switches can be envisaged for use in the control mechanism.

For top rope climbing the switch operation acts so as to reel in the rope when it is not under tension and the reel is in the first position. When the rope is under tension and the reel moves to the second position the switch or switches operate to stop the reel. For smooth operation, continuous uptake of the rope as the user climbs and near immediate stopping when the user pauses, it is desirable that the amount of movement of the reel about the pivot is small. Typically the movement can be as little as 5 mm.

For lead climbing the switch operation controls a different action. The rope unwinds when under light tension, stops when slack or when under a tension substantially equal to or greater than the weight of a user. The override switch mechanism is operated when the weight of the user is on the rope, i.e. where the apparatus for providing ascent assistance has been switched to fall or descent mode. In this circumstance lowering of a user to the ground may then be desired or required. The override switch mechanism inputs to the electronic control and diagnostic system which can allow descent to occur, for example when permitted by a timer mechanism or when commanded by a remote control device carried by the user, as mentioned previously.

The override switch mechanism may comprise a biasing means which prevents a switch, for example a micro-switch, being operated until the rope is subjected to at least the weight of a user and the tension displaces the winding reel from its biased position to operate the switch. For example the biasing means may comprise a compression spring or a counterweight.

Alternative mechanisms for, the override switch can be envisaged, for example releasing the reel to unwind the rope could be initiated after an electronic load cell or strain gauge measures the load being applied to the winding reel and rope assembly. Where an electric motor is employed to power the winding reel electronic monitoring of the loading on the motor can be used.

Preferably the control mechanism further comprises a remote control device to switch, on the winding reel power and to override the normal operation of the control mechanism when required e.g. for maintenance as previously described.

Preferably the control mechanism comprises; a lever, operable in use by said rope, and a biasing means, said lever and said biasing means being formed and arranged so that in use of said apparatus for providing ascent assistance said lever is held in a first position by the biasing means when the rope is not under tension and moves to a second position when said rope is under tension; at least one switch for controlling the powering of the winding reel, said switch being operated when the lever moves between said first and second positions; and an override switch mechanism, said override switch mechanism being activated when said rope is under a tension substantially equal to or greater than the weight of a user attached to said rope and in use of the device, allowing said winding reel to unwind until tension is reduced.

The switch or switches, which are operated when the lever moves, may be, for example, micro switches which operate when contacted by the lever. As an alternative to the use of micro switches a potentiometer may be used. The potentiometer may be mounted on a bearing of the winding drum and reacts to the movement of the lever to provide continuous feedback, as to the position and/or movement of the lever, to the programmable electronic control system. This arrangement gives a reduced number of moving parts together with increased sensitivity to lever arm movement.

The biasing means can be for example a weight or weights, which act to keep the lever in the said first position. Advantageously, the sensitivity of the control mechanism can be adjusted for different situations by varying the number or size of weights installed. It has been found during testing of a apparatus for providing ascent assistance of the invention where a lever mechanism is employed that the optimum weight required for different climbing situations can vary significantly (from 1 kg to 9 kg with the equipment used), in particular depending on the friction imposed on a rope as it passes over climbing surfaces and through intermediate anchorage points. Advantageously, as an alternative to weights, the biasing means may comprise an electrically operated actuator tensioning a biasing member, such as for example a spring, which acts to apply a variable load to the lever. Such a mechanism has the advantage that it can easily be adjusted to apply the optimum load to the lever for a given situation. As a user prepares to climb a wall or obstacle he can operate a controller, for example by turning a dial, to gradually increase the load imposed on the lever by the actuator and biasing member. When the rope just starts to move upwards, by operation of the winding reel, the load on the lever is set to compensate for the friction applied to the rope. Where an electrical actuator and biasing member are used to provide a variable load (resistance) to the lever, the use of a potentiometer to determine the actions of the lever, as described above is particularly preferred. The electronic control and diagnostic system can be used to control the actuator to deliver a progressive resistance via the biasing member to the lever.

As an alternative to an arrangement where the motor drives the winding reel directly via a gear box, a clutch mechanism can be inserted in the drive chain. For example, the motor may, via a gearbox, constantly drive a shaft to which the winding reel attaches only when a clutch mechanism, for example an electromagnetic clutch, is activated to grip the driven shaft. Such an arrangement can for example use the control mechanism comprising the lever and biasing means as described above to control the operation of the clutch.

Such an arrangement can be used in top rope climbing or lead climbing.

In top rope climbing when the rope is not under tension the clutch is activated by the control mechanism and the winding reel is driven to wind in the rope. When the rope is under tension the clutch disengages from the driven shaft, causing the winding reel to stop.

In lead climbing when the rope is under tension (not sufficient to operate the override switch mechanism) the clutch engages the driven shaft to pay out rope. When the rope is not under tension the clutch disengages from the driven shaft and winding stops.

Since the winding reel is in this case not directly attached to a gearbox and motor it is not constrained from turning and rapidly paying out rope when the weight of a user tensions the rope. Therefore to prevent uncontrolled descent, when the override switch of the control mechanism operates, as a consequence of the weight of a user on the rope, the clutch is commanded to rapidly engage and disengage repeatedly with the driven shaft. This has the effect of gradually lowering the user to the ground as the winding reel is both turned by the weight of the user and braked by the intermittent engagement with the driven shaft, via the clutch.

This arrangement has a particular benefit. It allows operation of more than one winding reel from a single motor. The motor constantly drives a shaft to which several winding reels can be attached at intervals, for example spaced along the top of an indoor climbing wall for top rope climbing. Each winding reel engages as required with the driven shaft via a clutch controlled by control mechanisms such as described before. This allows several users to climb without the need to provide a separate motor for each. Additionally, descent is automatic when the weight of a user tensions the rope, no command from a remote control device is required.

It will be apparent that features of the first, second, third or fourth aspects of the invention may be present in any of the other aspects of the invention.

Further preferred features and advantages of the present invention will appear from the following detailed description of some embodiments illustrated with reference to the accompanying drawings in which:

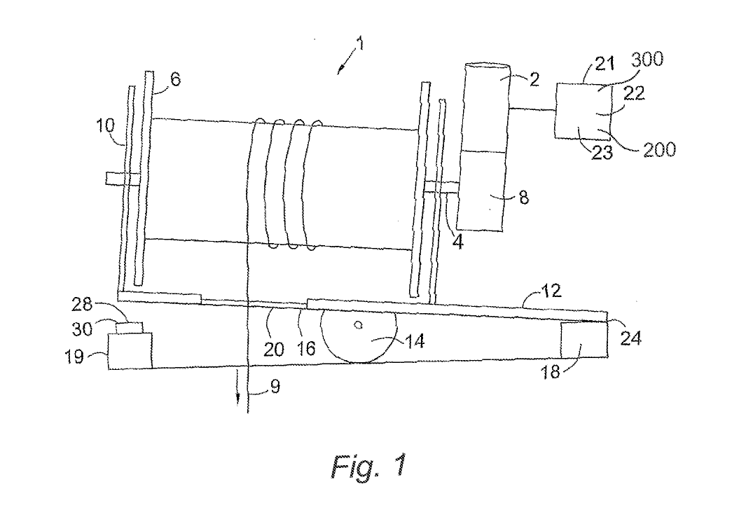

FIG. 1 shows an simple embodiment of a system for providing climb assistance of the invention arranged for top rope climbing;

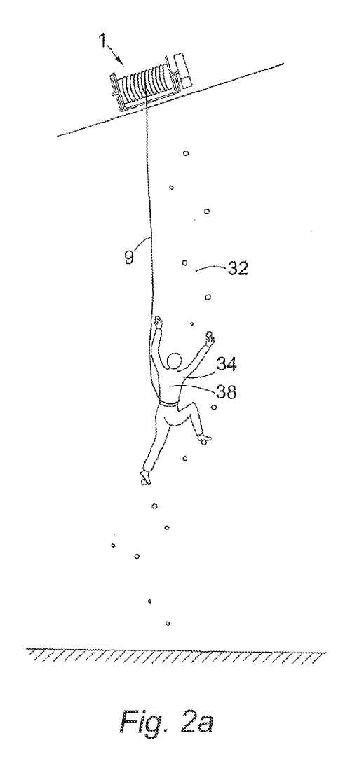

FIGS. 2a-b illustrate schematically the use of a system for providing climb assistance of the invention in top rope and lead climbing;

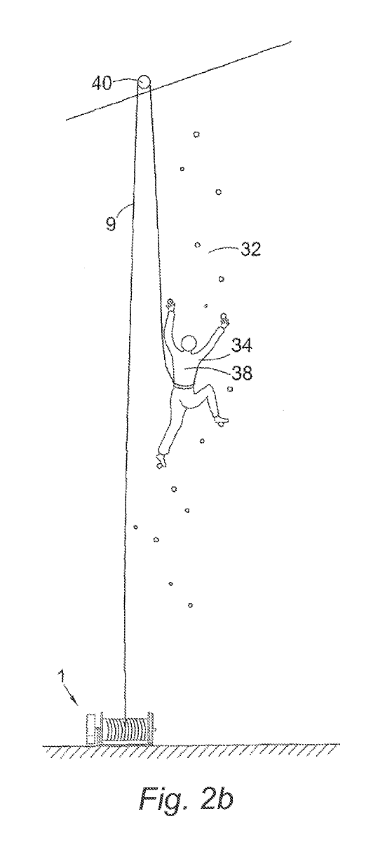

FIG. 3 shows another embodiment of a apparatus for providing climb assistance according to the invention with an alternative control mechanism;

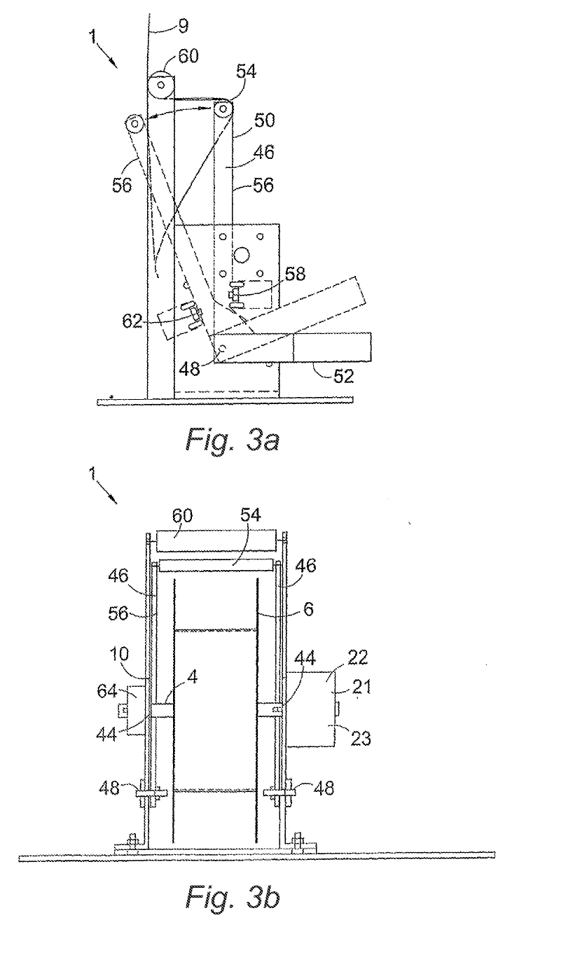

FIG. 4 shows an embodiment of the system for providing climb assistance of the invention where three winding reels are driven from a single motor to which they engage by clutch mechanisms;

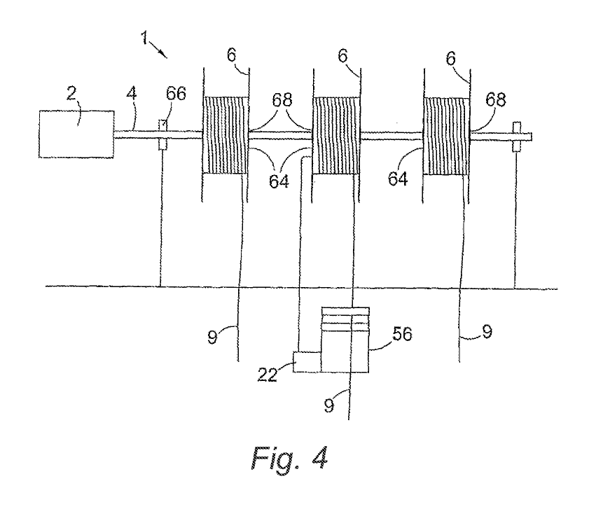

FIG. 5 shows a further alternative embodiment of the system for providing climb assistance;

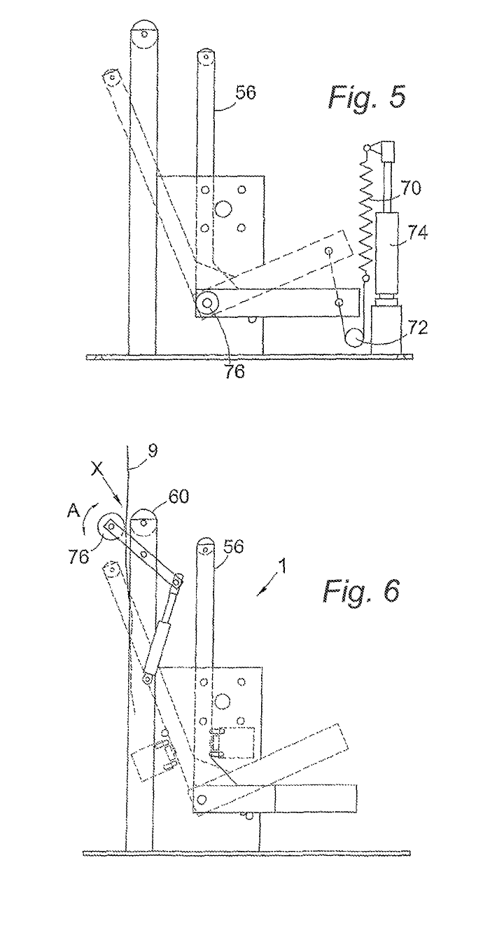

FIG. 6 shows a yet further embodiment of the system for providing climb assistance with a nip roller mechanism fitted;

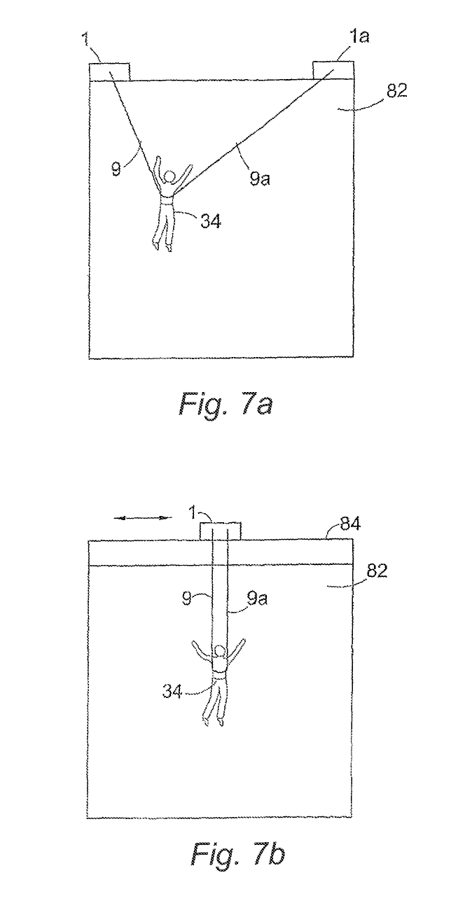

FIG. 7 (a,b) illustrates schematically the use of system for providing climb assistances of the invention to provide access to the face of a building; and

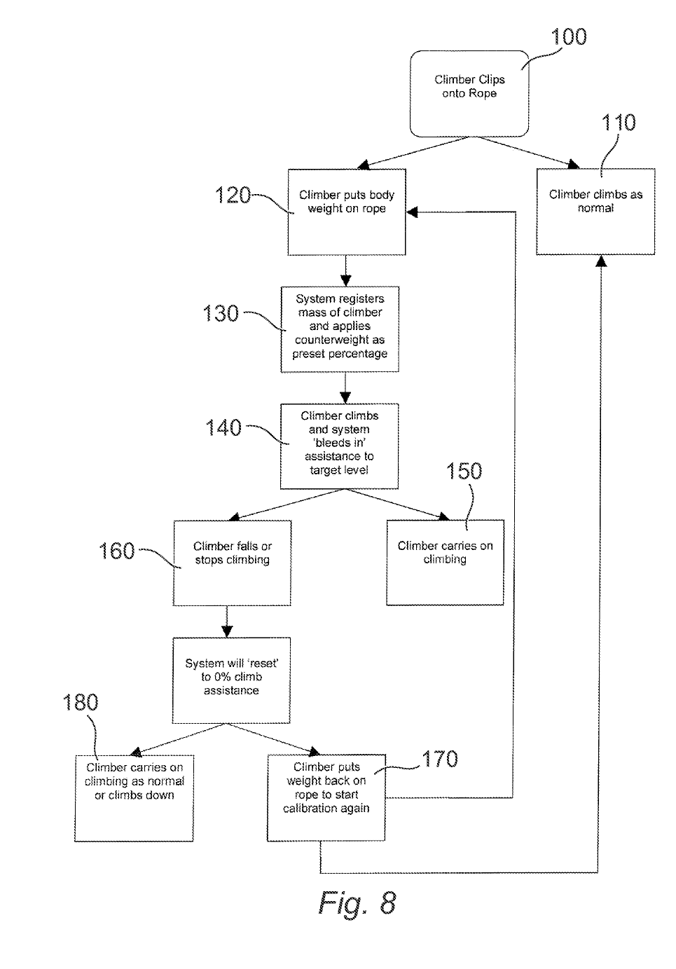

FIG. 8 is a flow chart representing the operation of a system for providing climb assistance in accordance with an embodiment of the present invention.

In the drawings, similar features are denoted by the same reference signs throughout.

FIG. 1 shows an embodiment of the system for providing climb assistance of the invention. A apparatus for providing climb assistance 1 comprises an electric motor 2, which drives a centre shaft 4 of a winding reel 6 via a gearbox 8. The winding reel 6 has a climbing rope 9 attached (only a few turns of rope 9 are shown for clarity in FIG. 1).

The winding reel, electric motor and gearbox are mounted on a cradle 10, which has a base plate 12. The base plate 12 is mounted on a horizontal pivot 14. The pivot 14 is positioned near, but not at, the balance point 16 of the device so that, in the absence of a load applied via the climbing rope 9, the cradle 10 tilts under gravity to rest on a support 18. When the rope 9 is under tension the cradle 10 tilts to rest on a second support 19.

In the example shown the apparatus for providing climb assistance 1 is to be sited at the top of a structure and used for top rope climbing, with the climbing rope 9 feeding downwards through a slot 20 in the base plate 12.

A control box 21 contains the electronic control and diagnostic system 22 and an inverter 23, which controls the operation of the electric motor 2. The control box 21 further contains a load sensor 200 and a haulage force applicator 300. In use of the system for providing climb assistance, when the rope 9 is not under tension (i.e. is slack) the cradle rests on the support 18 and a micro-switch 24 located on the base plate 12, between the base plate 12 and the support 18 is operated by their contact. The micro-switch 24 signals the electronic control and diagnostic system 22, which causes the inverter 23 to power the motor 2 to operate so that the winding reel 6 winds in the rope 9. When the rope 9 comes under tension, i.e. the slack has all been taken up; the apparatus for providing climb assistance 1 tilts about the pivot 14 until it rests on a second support 19. A second micro-switch 28 is operated by the contact of the base plate 12 to the second support 19, signalling the electronic control and diagnostic system 22 to stop the motor 2 when the user is in the unassisted climb mode.

In alternative examples, microswitch 28 may be replaced by load/pressure sensors which rope runs over or, in further alternatives, the entire apparatus is a drum with shaft running through centre which has a torque sensor associated therewith.

If the user wishes to utilise the assisted climb mode, the calibration mode must first be performed. The user calibrates the system by putting their full weight on the rope 9 for a set period of 3 to 5 seconds duration. The load sensor 200 detects the weight of the user and the haulage force applicator 300 determines the amount of haulage force to be exerted on the rope by the winding reel. The amount of haulage force (hf) applied will be derived by multiplying the applied assistance “a” required (as a percentage of the load detect) by the detected load “dl”. Before activating the system, a user can pre-programme the level of applied assistance “a”. Typically, the applied assistance will be between 10% and 70%. Following the calibration mode, as the user begins his/her ascent, the rope 9 is wound in by the winding reel 6 and microswitch 28 is operated by the contact of the base plate 12 to the second support. The signals to the haulage force applicator 300 that the haulage force should be applied to the rope 9 by the winding reel 6.

Also located on the second support 19 is an override switch mechanism 30 comprising a compression spring and a third micro-switch.

When the tension in the rope 9 is released (as a user climbs higher) the apparatus for providing climb assistance then pivots under the influence of gravity to rest once more on the first support 18 where the operation of the first micro-switch 24 initiates the winding in action again. Thus the tilting of the device about the pivot 14 as the rope 9 is tensioned and released by the actions of a user is used to control the operation of the winding reel 6 to keep the rope 9 properly taut during climbing.

In either assisted or unassisted climb modes, in the event of a fall the rope 9 is tensioned by the entire weight of the user and so the device 1 tilts about the pivot 14 to rest on the second support 19 operating the second micro-switch 28 and so the motor 2 is stopped (not powered). The load sensor 200 determines that the full weight of the user is on the rope 9 by comparing the sensed load to the originally detected load during calibration. The ratios of the gears in the gearbox 8 are chosen so as to hold the user in position whilst suspended by the rope. The tension is the rope 9 caused by the weight of the user compresses the spring to allow operation the third micro-switch of the override switch mechanism 30. The operation of the override switch mechanism allows descent to be permitted. If a fallen user wishes to descend they can then use their wireless remote control device (not shown) to signal to the electronic control and diagnostic system 22 to initiate the un-winding of the rope 9 by the winding reel 6.

If calibration did not occur, the fall or descent mode is triggered by any weight being placed on the rope 9.

Similarly, when a user who has completed a climb wishes to descend, they simply let go of the climbing surface to allow their weight to tension the rope 9 causing the override switch mechanism 30 to operate and then use their remote control device to initiate the un-winding of the rope.

FIG. 2a shows a general view of the use of the system for providing climb assistance and apparatus for providing climb assistance 1 of FIG. 1 in top rope climbing. The apparatus for providing climb assistance 1 is situated at the top of a climbing surface 32. A user 34 ascends the climbing surface whilst attached to the rope 9, connected to the apparatus for providing climb assistance 1. The rope 9 is kept taut by the controlled winding in by the apparatus for providing climb assistance as described previously for FIG. 1. The user 34 carries a wireless remote control device 38 which is used to initiate the operation of the apparatus for providing climb assistance 1 at the start of climbing and to initiate descent (unwinding of the rope) when the weight of the user tensions the rope and operates the override switch mechanism.

FIG. 2b shows an alternative arrangement for top rope climbing where the apparatus for providing climb assistance 1 is situated at the bottom of a climbing surface 32. The rope 9 passes up and round a pulley 40 situated at the top of the climbing surface and then down to a user 34.

FIG. 3 shows a further embodiment of the apparatus for providing climb assistance according to the invention, which uses the movement of a lever, rather than the pivoting of a winding reel, gearbox and motor assembly as a whole, for control of the winding reel operation. The winding reel 6 is mounted in a support cradle 10 by bearings 44 at either end of its drive shaft 4. In the interests of clarity the motor and gearbox, which drive the winding reel shaft 4 are not shown in the illustration, the rope is only shown on the end view (FIG. 3a), and the end view does not show the winding reel. Two ‘L’ shaped arms 46 are mounted by pivots 48 to the support cradle 10 at either end of the winding reel so they both rotate about the same axis parallel to the winding reel shaft 4 from a first position (shown in solid line in the end view FIG. 3a) to a second position (shown in dashed line in end view FIG. 3a).

The arms 46 each have a generally vertical portion 50 and a generally horizontal portion 52 making up the ‘L’ shape. The arms 46 are connected to each other by a horizontally disposed roller 54 attached at each end to the top ends of the generally vertical portion 50 of the L shaped arms 46 to form a control lever 56. The vertical portions are of sufficient length so that the roller 54 is held clear above the winding reel and a climbing rope 9 wound round it, even when the rope 9 is fully wound in.

The generally horizontal portions 52 of the ‘L’ shaped arms 46 are weights which act to bias the control lever assembly 56 about the pivots 48 to the first position, where one of the vertical portions 50 contacts and operates a first micro-switch 58.

The climbing rope 9 winds round the winding reel 6 and is lead up and round the roller 54 of the control lever assembly and then round a fixed roller 60 up to a user (who is not shown in this figure). The fixed roller 60 is mounted on the support cradle 10 and turns on a horizontal axis that is parallel to, but displaced horizontally from, the roller 54 of the control lever 56 when it is in the first position. The horizontal displacement of the fixed roller 60 is in the direction opposite to the direction of bias to the control lever 56 caused by the horizontal portions (weights) of the L shaped arms. In use for top rope climbing, in assisted climbing mode, when the rope 9 is not under tension the control lever assembly remains biased to the first position and the micro-switch 58 is operated signalling electronic control and diagnostic system 22 to operate the motor and gear box to cause the winding reel 6 to wind in the rope 9 (take up slack) . When the rope 9 comes under tension the portion of the rope 9 between the fixed roller 60 and the winding reel acts to pull the control lever assembly to the second position where a second micro-switch 62 is operated by the contact of the vertical portion 50 of one of the ‘L’ shaped arms 46 and causes the electronic control and diagnostic system 22 to stop the motor and winding reel 6.

When the tension in the rope 9 is released (as the a user climbs higher) the control lever 56 moves back to the first position again under the biasing influence of the horizontal portions (weights) 52 of the L shaped arms 46 and the movement of the control lever 56 between the first and second positions as the rope 9 is tensioned and released by the actions of a user is used to control the operation of the winding reel 6 to keep the rope 9 properly taut during top rope climbing.

For assisted climbing, a calibration of the system is carried out as described in respect of previous embodiments and the haulage force applicator acts to apply the determine haulage force to the rope 9 via the winding reel 6 when the second micro-switch 62 is operated.

An override switch mechanism 64 is provided, operating when the line is under a tension equal to or greater than the weight of a user, in this example it is a sensor measuring the load on the winding reel which signals the control box 22 to engage descent mode. When in descent mode a user is held in position (the winding reel is stopped) and can, if he wishes to descend, use a wireless remote control to signal the control box to operate the motor to cause the rope to unwind, lowering the user to the ground.

For lead climbing the operation of the winding reel 6 in response to the position of the control lever 56 is reversed i.e. electronic control and diagnostic system 22 is programmed to respond differently to the signals of the micro-switches. The winding reel 6 pays out line when under tension (when the lever is in the second position) i.e. as the user climbs and the rope is pulled up. The winding reel stops when the rope 9 is not under tension (the lever is in the first position).

For lead climbing with this embodiment, the override switch 64 stops the winding reel 6 when under tension equal to or greater than the weight of the user. This allows the user to continue climbing after a fall without losing height caused by winding out of the rope immediately after a fall.

FIG. 4 shows an embodiment of the system for providing climb assistance of the invention for mounting at the top of a climbing surface for use in top rope climbing. In normal use a motor 2 constantly drives a shaft 4 mounted in suitable bearings 66. Three winding reels 6 with associated climbing ropes 9 are mounted on the shaft 4 and each can engage separately with it by the operation of electromagnetic clutches 68. The electromagnetic clutches 68 are each separately controlled by lever control mechanisms 56 (only one shown for clarity) of the same general form as that of the embodiment of FIG. 3. The lever control mechanisms 56 respond to tension in their respective ropes 9 by signalling the electronic control and diagnostic system 22, which operates the electromagnetic clutch 68 to engage or disengage the winding reel 6 with the driven shaft or, when in assisted climb mode, to engage the winding reel 6 and to apply a determined haulage force to the rope 9 via the winding reel 6.

In use each winding reel 6 attaches via its clutch 68 to the shaft 4 when the respective rope 9 is not under tension so that the rope is wound in on the winding reel 6. When the rope is under tension the control lever 56 moves and signals to the electronic control and diagnostic system 22, which releases the clutch 68, stopping winding in. If the tension is equal to or greater than the weight of a user a sensor detecting the load on the winding reel (override switch mechanism 64) signals the electronic control and diagnostic system 22 to engage a descent mode where the electromagnetic clutch 68 rapidly engages and disengages the winding reel 6 with the driven shaft 4. The weight of the user on the rope causes the winding reel 6 to unwind the rope 9 but the speed of descent is moderated to a safe rate by the braking action when the clutch 68 intermittently engages the winding reel 6 to the shaft 4.

FIG. 5 shows another embodiment of a system for providing climb assistance of the invention, generally similar to that of FIG. 3 except that the control lever 56 is not weighted as a means to bias it to its first position and alternative means are used to detect the movement of the lever 56. In this example the lever 56 is biased to the first position by a spring 70, as biasing member, operating about a pulley 72. The tension applied by the spring 70 is adjustable by means of an electrically operated actuator 74, which is controlled by the electronic control and diagnostic system 22 (not shown, see FIG. 3b). In this case, as an alternative to micro switches the position and movement of the lever 56 is detected by a potentiometer 76, mounted on a bearing of the winding reel 6, which transmits signals to the electronic control and diagnostic system 22 (see FIG. 3b) to control the winding reel operation and the operation of the actuator 74. In use the potentiometer 76 can be more sensitive than an arrangement that employs micro-switches leading to more sensitive monitoring of the lever arm.

FIG. 6 shows an embodiment similar to that of FIG. 3, which shows a nip roller 76 mounted on a pivot 78 and moveable by means of an electrically operated actuator 80. The nip roller 76, can be moved by the actuator 80 about an arc indicated by the curved arrow A. When the apparatus for providing climb assistance 1 is in normal use during climbing the nip roller 76 is spaced apart from the fixed roller 60 so as not to interfere with the safe operation of the control lever 56. When a length of rope 9, not under tension from being attached to a user, has to be wound back onto the winding reel (not shown in this view, see FIG. 3b) the apparatus for providing climb assistance 1 is put into a rewind mode where the actuator 80 moves the nip roller 76 close to the fixed roller 60 to grip the rope at the point X. This has the effect of applying tension to the rope as it is wound onto the winding reel ensuring that no loose loops of rope form on the winding reel.

FIG. 7a shows two apparatus for providing climb assistance s 1,1a of the invention located at either end of the top edge of a wall 82 of a building. A user 34 is attached by ropes 9,9a, to each of the apparatus for providing climb assistance s 1,1a. By using a wireless remote control (not shown) the user 34 can be lifted by the operation of the apparatus for providing climb assistance s 1,1a. By commanding different amounts of each rope 9,9a to be wound in by the apparatus for providing climb assistance s 1,1a the user traverse across the surface of the wall 82 as well as be lifted up or down.

FIG. 7b shows a apparatus for providing climb assistance 1 mounted on a rail 84 along the top edge of a building wall 82. A user 34 is attached to the apparatus for providing climb assistance 1, which has a partitioned winding reel, by two ropes 9,9a. The second rope provides additional safety. In use the user can operate the winding reel of the apparatus for providing climb assistance 1 to raise or lower himself and also cause the apparatus for providing climb assistance 1 to move along the rail 84 by means of an electric motor. Thus the user 34 can reach any part of the wall 82 to carry out maintenance work.

FIG. 8 shows a flow diagram representative of the various modes of the calibration device, the apparatus for providing climb assistance and the system for providing climb assistance of the present invention.

In particular, at 100, the system for providing climb assistance is in idle mode ready for initiation of either the first, calibration mode or the third, unassisted climb, mode.

If a user chooses to ascend unassisted, the user proceeds to 110 wherein the system for providing climb assistance operates in the unassisted climb mode wherein the winding reel operates to prevent slack in the rope between the user and the winding reel and the load sensing means is formed and arranged to detect the weight of the user on the rope and to switch the operation of the winding reel to the fourth, fall or descent, mode wherein the winding reel is stopped and the user is suspended by the rope.

If a user chooses to activate the assisted climb mode, the user proceeds to 120 where s/he puts all their weight onto the rope such that the calibration mode is initiated and the load sensing means detects the load on the rope. If the user only puts a % of their weight on the rope it will obviously calibrate with a lesser load value. After a preselected period of between 3 and 5 seconds, an audible signal is communicated to the user to indicate that the calibration mode has been completed successfully and that the preselected haulage force has been determined as a percentage of the load applied to the rope by the user. If a haulage force of 80% of the load applied to the rope is required, this 80% haulage force is programmed into the system for providing climb assistance prior to step 120. Thereafter, if the calibration mode is successfully completed and the assisted climb mode initiated 130, the haulage force applied by the haulage force application means will be equal to 80% of the load detected by the load sensing means.

At 140, the user ascends in the assisted climb mode whilst the determined haulage force is applied to the rope via the winding reel to assist the user in the ascent.

The user may then complete the ascent in assisted climb mode 150.

Alternatively, if the user falls or pauses for more than 5 seconds, the system for providing climb assistance will remove the haulage force and the system will initiate the fall or descent mode or the unassisted climb mode as appropriate, 160.

At 170, the user may then re-calibrate the system for providing climb assistance and continue to ascend in the assisted climb mode or, alternatively, at 180, (180 should really be shown linking back to 110) may continue to ascend in unassisted climb mode or may descend without assistance.

The apparatus for providing climb assistance and system provides a level of assistance to a user in an ascent which level of assistance is always less than the total load of a user unless the lift mode is initiated. In this way, the risk of the user setting the system incorrectly and being lifted involuntarily into a dangerous system is eliminated.

Furthermore, because the apparatus for providing climb assistance and system automatically detect a change in the load on the rope by way of the load sensing means, no manual intervention is required for one user to be swapped for another thereby changing the load or otherwise depositing or picking up equipment thereby reducing or increasing the load detected by the load sensing means.

Because the apparatus for providing climb assistance and system automatically detect a change in the load on the rope by way of the load sensing means, there is no risk of a subsequent user inheriting the system settings of a previous user.

Due to the intelligent determination of the applicable haulage force to the rope, a greater haulage force than is applicable by known systems is possible as there is no risk of the haulage force ever being greater than the load on the rope.

Various modifications may be made to the embodiments described above without departing from the scope of the present invention.

In particular, although the embodiments described with reference to the Figures are directed to climbing and climb assistance, it should be readily understood that the features detailed therein are applicable to any ascent and/or descent.

The aspects of the present invention have application in a number of fields including, but not limited to, industrial access, evacuation, rescue, climb assistance, fall prevention and work positioning, for example.

1. A load calibration device comprising;
a motive force generator;
a motive force applicator operably linked to the motive force generator and, in use of the load calibration device, an object to which the motive force applicator applies a motive force;
a control mechanism having a load sensing means, and a haulage force application means;
said control mechanism being formed and arranged so as to control the motive force generator in a first, calibration, mode wherein the motive force generator is stopped;
wherein the load sensing means is formed and arranged to detect a load applied to the motive force applicator by the object and said haulage force application means is operable to determine an amount of haulage force to be applied to the motive force applicator by the motive force generator in accordance with the equation hf equals dl multiplied by a, where: “hf” equals haulage force in kg; “dl” equals detected load (load detected by the load sensing means) in kg and “a” equals applied assistance as a percentage; and
wherein a signal is communicated to a user to signal the successful calibration of the device.

2. A load calibration device according to claim 1, wherein the object comprises a user.

3. A load calibration device according to claim 1, wherein the object comprises equipment, tools or other inanimate object.

4. A load calibration device according to claim 1, wherein the motive force generator comprises one or more of a powered winding reel, a hoist, a cable traction device, a capstan, a pulley, a counterweight device and/or a powered lifting device.

5. A load calibration device according to claim 1, wherein the motive force applicator comprises a rope.

6. A load calibration device according to claim 1, wherein the motive force generator is a powered winding reel and the motive force applicator is a rope, the rope being attached to the winding reel and, in use of the device, to said object.

7. A load calibration device according to claim 5, wherein the rope is a continuous loop.

8. A load calibration device according to claim 5, wherein the rope is attached at one end to the motive force generator and, in use of the device, to said object a distal portion along the rope.

9. A load calibration device according to claim 1, wherein the motive force applicator is a platform.

10. A load calibration device according to claim 1, wherein the applied assistance “a” ranges from between 0% and 99%.

11. A load calibration device according to claim 10, wherein the applied assistance “a” ranges from between 10% to 70%.

12. A load calibration device according to claim 1, wherein the haulage force may be up to a maximum of 140 kg.

13. A load calibration device according to claim 1, wherein the haulage force application means is operable to determine an amount of haulage force to be applied to the motive force applicator by the motive force generator after the load has been detectable by the load sensing means for a preselected period.

14. A load calibration device according to claim 13, wherein the preselected period may be 0 to 10 seconds.

15. A load calibration device comprising;
a powered winding reel;
a rope attached to the winding reel and, in use of the device, to a user;
a control mechanism having a load sensing means, and a haulage force application means; and
said control mechanism being formed and arranged so as to control the powered winding reel in a first, calibration, mode wherein the winding reel is stopped, and further wherein the load sensing means is formed and arranged to detect a load applied to the rope and said haulage force application means is operable to determine an amount of haulage force to be applied to the rope by the winding reel in accordance with the equation hf equals dl multiplied by a, where: “hf” equals haulage force in kg; “dl” equals detected load (load detected by the load sensing means) in kg and “a” equals applied assistance as a percentage and further wherein a signal is communicated to a user to signal the successful calibration of the device.

16. A load calibration device according to claim 15, wherein the rope is a continuous loop.

17. A load calibration device according to claim 15, wherein the rope is attached at one end to the winding reel and, in use of the device, to a user a distal portion along the rope.

18. A load calibration device according to claim 15, wherein the applied assistance “a” ranges from between 0% and 99%.

19. A load calibration device according to claim 18, wherein the applied assistance “a” ranges from between 10% to 70%.

20. A load calibration device according to claim 15, wherein the haulage force may be up to a maximum of 140 kg.

21. A load calibration device according to claim 15, wherein the haulage force application means is operable to determine an amount of haulage force to be applied to the rope by the winding reel after the load has been detectable by the load sensing means for a preselected period.

22. A load calibration device according to claim 21, wherein the preselected period may be 0 to 10 seconds.

23. An apparatus for providing ascent assistance comprising:
a motive force generator;
a motive force applicator operably linked to the motive force generator and, in use of the apparatus, an object to which the motive force applicator applies a motive force; and
a control mechanism comprising a load sensing means and a haulage force application means;
said control mechanism being formed and arranged so as to control the motive force generator in a first, calibration, mode wherein the motive force generator is stopped, and further wherein the load sensing means is formed and arranged to detect a load applied to motive force applicator by the object and said haulage force application means is operable to determine an amount of haulage force to be applied to the motive force applicator by the motive force generator in accordance with the equation hf equals dl multiplied by a, where: “hf” equals haulage force in kg; “dl” equals detected load (load detected by the load sensing means) in kg and “a” equals applied assistance as a percentage;
the control mechanism being operable to switch the operation of the motive force generator into a second, assisted ascent mode wherein the motive force generator initially acts upon the motive force applicator until the load detected by the load sensing means is substantially equal to the weight of the motive force applicator; and
wherein said haulage force application means is operable to apply said determined haulage force to the motive force applicator by way of the motive force generator, which haulage force acts upon the motive force applicator in opposition to the load.

24. An apparatus for providing ascent assistance according to claim 23, wherein the object comprises a user.

25. An apparatus for providing ascent assistance according to claim 23, wherein the object comprises equipment, tools or other inanimate object.

26. An apparatus for providing ascent assistance according to claim 23, wherein the motive force generator comprises one or more of a powered winding reel, a hoist, a cable traction device, a capstan, a pulley, a counterweight device and/or a powered lifting device.

27. An apparatus for providing ascent assistance according to claim 23, wherein the motive force applicator comprises a rope.

28. An apparatus for providing ascent assistance according to claim 23, wherein the motive force generator is a powered winding reel and the motive force applicator is a rope, the rope being attached to the winding reel and, in use of the apparatus, to said object.

29. An apparatus for providing ascent assistance according to claim 27, wherein the rope is a continuous loop.

30. An apparatus for providing ascent assistance according to claim 27, wherein the rope is attached at one end to the motive force generator and, in use of the device, to said object a distal portion along the rope.

31. An apparatus for providing ascent assistance according to claim 23, wherein the motive force applicator is a platform.

32. An apparatus according to claim 23, wherein the applied assistance “a” ranges from between 0% and 99%.

33. An apparatus according to claim 23, wherein the applied assistance “a” ranges from between 10% to 70%.

34. An apparatus according to claim 23, wherein the object is a person/user and the haulage force is up to a maximum of 140 kg equivalent.

35. An apparatus according to claim 23, wherein the haulage force application means is operable to determine the amount of haulage force applicable to a load in response to the detection of that load by the load sensing means.

36. An apparatus according to claim 23, wherein the first, calibration mode is preceded by a pre-calibration mode in which the control mechanism is formed and arranged so as to control the motive force generator to equalise the force differential with the object until the load sensing means detects a constant load for a predetermined time.

37. An apparatus according to claim 23, wherein in the first, calibration, mode the haulage force application means is operable to determine an amount of haulage force to be applied to the motive force applicator by the motive force generator after the load has been detectable by the load sensing means for a preselected period.

38. An apparatus according to claim 37, wherein the preselected period is in the range 0 to 10 seconds.

39. An apparatus according to claim 23, wherein a signal is communicated to the operator or user to signal the successful calibration of the device.

40. An apparatus according to claim 23, wherein when the apparatus is in the second, assisted ascent, mode the load sensing means is operable to detect a change in the load on the motive force applicator.

41. An apparatus according to claim 23, wherein when the apparatus is in the second, assisted ascent, mode and the load sensing means detects a change in the load on the motive force applicator, the control mechanism is operable to switch the operation of the motive force generator to a third, unassisted ascent, mode wherein the motive force generator initially acts upon the motive force applicator until the load detected by the load sensing means is substantially equal to the weight of the motive force applicator and wherein the haulage force application means ceases to apply the haulage force to the motive force applicator by way of the motive force generator.

42. An apparatus according to claim 23, wherein when the apparatus is in the second, assisted ascent, mode and the load sensing means detects a load substantially equal to the load detected by the load sensing means in the first, calibration, mode on the motive force applicator, the control mechanism is operable to switch the operation of the motive force generator to a fourth, fall or descent mode, wherein the motive force generator is stopped and the haulage force application means ceases to apply the haulage force to the motive force applicator by way of the motive force generator and the user is maintained in position by the motive force applicator.

43. An apparatus for providing climb assistance comprising:
a powered winding reel;
a rope attached to the winding reel and, in use of the device, to a user;
a control mechanism comprising a load sensing means and a haulage force application means;
said control mechanism being formed and arranged so as to control the powered winding reel in a first, calibration, mode wherein the winding reel is stopped, and further wherein the load sensing means is formed and arranged to detect a load applied to the rope and said haulage force application means is operable to determine an amount of haulage force to be applied to the rope by the winding reel, said haulage force being determined in accordance with the equation hf equals dl multiplied by a, where: “hf” equals haulage force in kg; “dl” equals detected load (load detected by the load sensing means) in kg and “a” equals applied assistance as a percentage;
the control mechanism being operable to switch the operation of the winding reel into a second, assisted climb, mode wherein the winding reel operates to prevent slack in the rope between said user in use of the device and said winding reel; and
said haulage force application means is operable to apply a haulage force to the rope by way of the winding reel, which haulage force provides climb assistance to the user at the determined force.

44. An apparatus according to claim 43, wherein the applied assistance “a” ranges from between 0% and 99%.

45. An apparatus according to claim 43, wherein the applied assistance “a” ranges from between 10% to 70%.

46. An apparatus for providing climb assistance according to claim 43, wherein, in the first, calibration, mode the haulage force application means is operable to determine an amount of haulage force to be applied to the rope by the winding reel after the load has been detectable by the load sensing means for a preselected period.

47. An apparatus for providing climb assistance according to claim 46, wherein the preselected period may be 0 to 10 seconds.

48. An apparatus for providing climb assistance according to claim 43, wherein a signal is communicated to the user to signal the successful calibration of the device.

49. An apparatus for providing climb assistance according to claim 43, wherein when the apparatus for providing climb assistance is in the second, assisted climb, mode the load sensing means is operable to detect a change in the load on the rope.

50. An apparatus for providing climb assistance according to claim 43, wherein when the apparatus for providing climb assistance is in the second, assisted climb, mode and the load sensing means detects a change in the load on the rope, the control mechanism is operable to switch the operation of the winding reel to a third, unassisted climb, mode wherein the winding reel operates to prevent slack in the rope between the user in use of the device and the winding reel and wherein the haulage force application means ceases to apply the haulage force to the rope by way of the winding reel.

51. An apparatus for providing climb assistance according to claim 43, wherein when the apparatus for providing climb assistance is in the second, assisted climb, mode and the load sensing means detects a load substantially equal to the load detected by the load sensing means in the first, calibration, mode on the rope, the control mechanism is operable to switch the operation of the winding reel to a fourth, fall or descent mode, wherein the winding reel is stopped and the haulage force application means ceases to apply the haulage force to the rope by way of the winding reel and the user is suspended by the rope.

52. An apparatus for providing climb assistance according to claim 43, wherein the control mechanism is operable to switch the winding reel into a third, unassisted climb, mode wherein the winding reel is operable to prevent slack in the rope between the user in use of the device and the winding reel and the haulage force application means provides no haulage force to the rope by way of the winding reel.

53. An apparatus for providing climb assistance according to claim 52, wherein when the apparatus for providing climb assistance is in the third, unassisted climb, mode the load sensing means is formed and arranged to detect the weight of a user on the rope and to switch the operation of the winding reel to a fourth, fall or descent mode, wherein the winding reel is stopped and the haulage force application means is operable to apply no haulage force to the rope by way of the winding reel and the user is suspended by the rope.

54. A apparatus for providing climb assistance according to claim 43, wherein the apparatus for providing climb assistance is configured to detect a stop or pause in the movement of the user during use of the device.

55. An apparatus for providing climb assistance according to claim 54, wherein the control mechanism, in detecting a pause or a stop in the movement of the user, is operable to switch the operation of the winding reel to the third, unassisted climb, mode, wherein the winding reel is operable to prevent slack between the user in use of the device and the winding reel and the haulage force application means ceases to apply the haulage force to the rope by way of the winding reel.

56. A system for providing ascent assistance comprising:
a motive force generator;
a motive force applicator operably linked to the motive force generator and, in use of the system, an object to which the motive force applicator applies a motive force;
a control mechanism comprising load sensing means, an electronic control and diagnostic system, and a haulage force application means;
said control mechanism being formed and arranged so as to control the motive force generator in a first, calibration, mode wherein the motive force generator is stopped, and further wherein the load sensing means is formed and arranged to detect a load applied to the motive force applicator and said haulage force application means is operable to determine an amount of haulage force to be applied to the motive force applicator by the motive force generator, in accordance with the equation hf equals dl multiplied by a, where: “hf” equals haulage force in kg; “dl” equals detected load (load detected by the load sensing means) in kg and “a” equals applied assistance as a percentage;
the control mechanism being operable to switch the operation of the motive force generator into a second, assisted ascent, mode wherein the motive force generator initially acts upon the motive force applicator until the load detected by the load sensing means is substantially equal to the weight of the motive force applicator, and said haulage force application means is operable to apply said determined haulage force to the motive force applicator by way of the motive force generator, which haulage force provides ascent assistance to the object; in operation of the second, assisted ascent, mode the load sensing means is formed and arranged to detect the weight of a said object on the motive force applicator, and to switch the operation of the motive force generator to a fourth, fall or descent mode;
wherein the motive force generator is stopped and a said object is maintained in position by the motive force applicator; and
the electronic control and diagnostic system is formed and arranged to monitor the operation of the motive force generator and the control mechanism, and to switch the operation of the motive force generator to a fifth, fault mode, when a fault is detected.

57. A system according to claim 56, wherein the object comprises a user.

58. A system according to claim 56, wherein the object comprises equipment, tools or other inanimate object.

59. A system according to claim 56, wherein the motive force generator comprises one or more of a powered winding reel, a hoist, a cable traction device, a capstan, a pulley, a counterweight device and/or a powered lifting device.

60. A system according to claim 56, wherein the motive force applicator comprises a rope.

61. A system for providing ascent assistance comprising:
a powered winding reel;
a rope attached the winding reel and, in use of the device, to a user;
a control mechanism comprising load sensing means, an electronic control and diagnostic system, and a haulage force application means, a control mechanism comprising a load sensing means and a haulage force application means;
said control mechanism being formed and arranged so as to control the powered winding reel in a first, calibration, mode wherein the winding reel is stopped, and further wherein the load sensing means is formed and arranged to detect a load applied to the rope and said haulage force application means is operable to determine an amount of haulage force to be applied to the rope by the winding reel, said haulage force being determined in accordance with the equation hf equals dl multiplied by a, where: “hf” equals haulage force in kg; “dl” equals detected load (load detected by the load sensing means) in kg and “a” equals applied assistance as a percentage;
the control mechanism being operable to switch the operation of the winding reel into a second, assisted ascent, mode wherein the winding reel operates to prevent slack in the rope between said user in use of the device and said winding reel, and said haulage force application means is operable to apply a haulage force to the rope by way of the winding reel, which haulage force provides ascent assistance to the user at the determined force;
the load sensing means is formed and arranged to detect the weight of a said user on the rope, and to switch the operation of the winding reel to a fourth, fall or descent mode;
wherein the winding reel is stopped and a said user is suspended by the rope; and
the electronic control and diagnostic system is formed and arranged to monitor the operation of the powered winding reel and the control mechanism, and to switch the operation of the winding reel to a fifth, fault mode, when a fault is detected.

62. A system for providing ascent assistance according to claim 61, wherein in the fifth, fault, mode a non-fatal error is detected, the system is operable to switch to a sixth, limp home, mode which disables all advanced functions of the system and sounds all alarms informing the user to return to a safe level and check system.

63. A system for providing climb assistance according to claim 61, wherein a seventh, lift, mode may be engaged to lift a user in pulses.

64. A method for assisting a user in an ascent when working at height, the method comprising the steps of:
providing a rope;
detecting a load applied to the rope in a first direction;
selecting a level of applied assistance to be provided to the user;
determining a haulage force in accordance with the equation hf equals dl multiplied by a,
where: “hf” equals haulage force in kg;
“dl” equals detected load (load detected by the load sensing means) in kg and “a” equals applied assistance as a percentage; and
applying the haulage force in a second direction to counterweight against the load applied to the rope in the first direction.

65. A method according to claim 64, further comprising one or more of the steps of:
signalling to a user on the rope that the haulage force has been determined;
providing a preselected time delay between the steps of determining a haulage force as a percentage of the load detected on the rope and that of applying the haulage force to counterweight against the load applied to the rope; and
removing the haulage force in response to a change in the load detecting on the rope.
